(19) United States
(12) Patent Application Publication
(10) Pub. No.: US 2008/0052911 A1
(43) Pub. Date: Mar. 6, 2008

(54) Shaving implement and method for using same

(75) Inventor: Chris M. Kohler, North Branford, CT (US)

Correspondence Address: Michaud-Duffy Group LLP, Suite 206, 306 Industrial Park Road, Middletown, CT, 06457, US

(73) Assignee: Eveready Battery Company, Inc., St. Louis, MO (US)

(21) Appl. No.: 11/897,049

(22) Filed: Aug. 28, 2007

Related U.S. Application Data
(60) Provisional application No. 60/841,695, filed on Sep. 1, 2006.

(51) Int. Cl. B26B 21/40; A45D 27/00; B26B 21/00

(52) U.S. Cl. 30/41.7; 30/526; 30/537

(57) ABSTRACT

In a wet-shave razor, a handle is provided and has a razor cartridge mounted thereon at an end thereof. The razor cartridge has at least one razor blade positioned therein. A sensor is mounted to the handle for continuously monitoring and detecting movement of the handle and generating signals indicative thereof. A controller is also mounted to the handle and is in communication with the sensor for continuously receiving signals from the sensor. An indicator is mounted to the handle and is in communication with the controller. During operation, the indicator generates an alert in response to commands received from the controller, the alert being identifiable by a user and indicative of the remaining useful life of the razor cartridge.

### CROSS REFERENCE TO RELATED APPLICATION

This application claims the benefit of Provisional Patent application Ser. No. 60/841,695, filed Sep. 1, 2006.

### FIELD OF THE INVENTION

The present invention relates generally to wet-shave razors and more particularly to wet shave razors having electronics integrally incorporated therein.

### BACKGROUND OF THE INVENTION

The useful life of a wet-shave razor cartridge is finite and once reached, performance rapidly deteriorates causing poor shave quality, discomfort, and possibly injury. However, determining how many shaving operations constitute a razor cartridge's useful life is often difficult and can depend on a number of factors. These factors include such things as the nature of the surface being shaved and the number of strokes a particular user takes to accomplish a shaving operation. Often, a user does not recall the number of shaving operations for which a particular razor or razor cartridge has been used. Accordingly, the user waits until shave quality noticeably deteriorates to change cartridges or razors.

Based on the foregoing, there is a current need for a wet-shave razor and/or razor cartridge that provides a user with information pertaining to the remaining useful life of the razor cartridge forming part of the wet-shave razor. Accordingly, it is the general object of the present invention to provide a wet shave razor that improves upon, or overcomes the problems and drawbacks associated with prior art wet shave razors.

### SUMMARY OF THE INVENTION

The present invention is directed in one aspect to a wet shave razor that includes a handle and a razor cartridge coupled to the handle. The razor cartridge has at least one razor blade positioned therein. A tilt sensor is provided for continuously monitoring and detecting movement of the wet shave razor and generating signals indicative thereof. A controller is also mounted to the wet shave razor and is in communication with the tilt sensor for continuously receiving signals there from and for issuing commands responsive to the received signals. An indicator is mounted to the handle and is in communication with the controller. The indicator generates an alert responsive to the commands issued from the controller generally indicative of the remaining useful life of the razor cartridge.

Preferably, the controller is located within an interior area defined by the handle. A power supply is also positioned in the interior area and is preferably in the form of a battery. A portion of the handle is removable to allow for replacement of the battery. However, the present invention is not limited in this regard.

In an embodiment of the present invention, the indicator includes one or more light emitting diodes (LED's) at least partially projecting from an outer surface of the handle so that the LED or LED's are visible to a user. In response to commands issued from the controller, the LED's can be selectively illuminated to provide information to the user generally indicative of the remaining useful life of the razor cartridge forming part of the wet shave razor. However, the present invention is not limited in this regard as the indicator can also be used to provide a user with alerts regarding such things as low battery power. In addition to being selectively illuminable, the LED's can also be of different colors with a particular color indicating a particular condition.

In lieu of LED's, a liquid crystal display (LCD) can be utilized. In a preferred embodiment of the present invention, the LCD is positioned in the razor handle with the LCD screen being located in an opening defined by an outer surface of the handle. The LCD is configured to display numeric values, graphics or combinations thereof in response to commands issued from the controller. For example the LCD can display a series of bars. The bars can be progressively larger or progressively smaller as they extend across the LCD screen. However, the present invention is not limited in this regard as the bar pattern can take on a number of different orientations, such as all of the bars being the same size and extending either vertically or horizontally across the LCD's screen. As the wet shave razor is used, the number of bars can be increased or decreased depending on how the remaining useful life of the razor cartridge is to be indicated.

For example, if the controller is programmed to command the indicator to provide an indication of the remaining useful life of the razor cartridge, the number of bars shown on the indicator may progressively decrease. On the other hand, if the controller is programmed to cause the indicator to provide an indication of the number of shaving operations for which the razor cartridge has been used the number of bars displayed by the LCD may progressively increase. In addition, the LCD may also be configured to display numbers indicative of the useful life of the razor cartridge forming part of the wet shave razor. Moreover, the graphic and numeric displays may be combined. Furthermore, the LCD can be made to blink or go blank if certain conditions are met, such as, the useful life of the razor cartridge has been exceeded, or the battery power is low.

In the preferred embodiment of the present invention, the tilt sensor detects tilting motion of the razor handle and generates signals indicative thereof that are receivable by the controller. These signals are used by the controller to qualify a series of tiling motions that occur within a predetermined time frame, as a valid shaving operation. The controller, (inter alia), counts the number of qualified shaving operations and stores this count therein. Means for resetting the controller and thereby the count are also provided and preferably include a magnetic reed switch in communication with the controller. The magnetic reed switch is also in communication with an actuator on the handle. The actuator is movable between a cartridge retaining position wherein the magnetic reed switch is in one of an open and closed position, and a cartridge releasing position wherein the magnetic reed switch is in the other of the open and closed positions. During use, when a razor cartridge is replaced, movement of the actuator from the cartridge retaining to the cartridge releasing position manipulates the magnetic reed switch thereby causing the controller to, among other things, reset. Once the controller is reset, the count of shaving operations stored therein is set to zero or a maximum value depending on whether the controller is configured to count up or down. In this manner the useful life of a new razor cartridge attached to the handle can be appropriately monitored by the controller. Commands issued from the controller can cause the indicator to alert the user that the razor cartridge is new. Means can also be provided to alert the controller to the type of razor cartridge mounted on the handle. This information can be employed by the controller to determine if different types of razor cartridges have different useful lives. The controller can then cause the indicator to convey the appropriate information to the user.

In an embodiment of the present invention, the wet-shave razor also includes a moisture sensor for detecting and generating signals indicative of changes in moisture level at the razor cartridge. The controller evaluates these signals, typically with respect to the amount of moisture detected and the rate at which moisture levels are changing. The moisture sensor can also be used in combination with the tilt sensor to determine when a shaving operation is occurring.

The present invention also resides in a method for monitoring the useful life of a razor cartridge wherein a wet-shave razor is provided that includes a tilt sensor for continuously monitoring and detecting movement of the wet shave razor. The tilt sensor generates signals that are receivable by the controller which evaluates the signals and if appropriate issues commands responsive to these received signals to the indicator. The indicator, as described above, forms part of the wet-shave razor and provides alerts to the user in the above-described manner responsive to the commands received from the controller. The alert provides the user with information generally indicative of the remaining useful life of the razor cartridge.

During operation, the tilt sensor detects initial tilting movements of the wet-shave razor. The controller measures the duration of the initial tilting movement and compares the duration to a first predetermined time value stored in the controller. The controller then monitors the amount of time that passes between the start of the initial tilting movement and the cessation thereof. If too much time elapses between the start of the initial tilting movement and the cessation thereof, or if no cessation is detected, the controller enters a sleep mode. However, if the tilting movement ceases within an acceptable time frame, the controller then looks for signals from the tilt sensor indicative of the next successive tilting movement. If a predetermined number of qualified tilting movements occur within a predetermined time, the controller then qualifies the series of tilting movements as a valid shaving operation.

In an embodiment of the method of the present invention, the controller is programmed to determine a pattern of razor cartridge useage relevant to a particular user and to issue commands indicative thereof to the indicator. The pattern is determined by monitoring the particular users razor cartridge usage over a predetermined number of razor cartridges and then calculating an average usage. This average usage is then used by the controller as the useful life of the razor cartridge and information indicative thereof is displayed to the user in response to commands issued by the controller. The average determined by the controller can be constantly updated so as to provide the user with accurate individualized information.

An advantage of the present invention is that the user is provided with information that allows him/her to change razor cartridges prior to experiencing shaving discomfort.

Another advantage of the present invention is, a user no longer has to remember when he/she last replaced a razor-cartridge.

Yet another advantage of the present invention is that cartridge usage and information relevant thereto can be individualized to a particular user's shaving habits.

### BRIEF DESCRIPTION OF THE DRAWINGS

FIG. 1 is a cross-sectional side view of a wet-shave razor embodying the present invention.

FIG. 2 is a partial top view of the wet-shave razor of FIG. 1 showing the indicators as comprising three LED's

FIG. 3 is a cross-sectional side view of an embodiment of the wet-shave razor of the present invention incorporating a moisture sensor.

FIG. 4 is an enlarged side view of a razor cartridge forming part of the wet-shave razor of FIG. 3 as indicated by the circle labeled “A.”

FIG. 5 is a cross-sectional top view of a wet-shave razor in accordance with present invention.

FIG. 6 is a cross-sectional top view of the wet-shave razor of FIG. 5 showing an LCD display in the handle.

FIG. 7 is front view of the LCD screen forming part of the LCD of FIG. 5.

FIGS. 8a-d illustrates different displays that can appear on the LCD screen of FIG. 7.

FIG. 9 is a state diagram schematically illustrating a process for qualifying a shaving operation.

FIG. 10 is a flow chart illustrating a usage system employing a moisture sensor and a tilt sensor as well as pattern recognition and an LCD.

### DETAILED DESCRIPTION OF THE PREFERRED EMBODIMENT

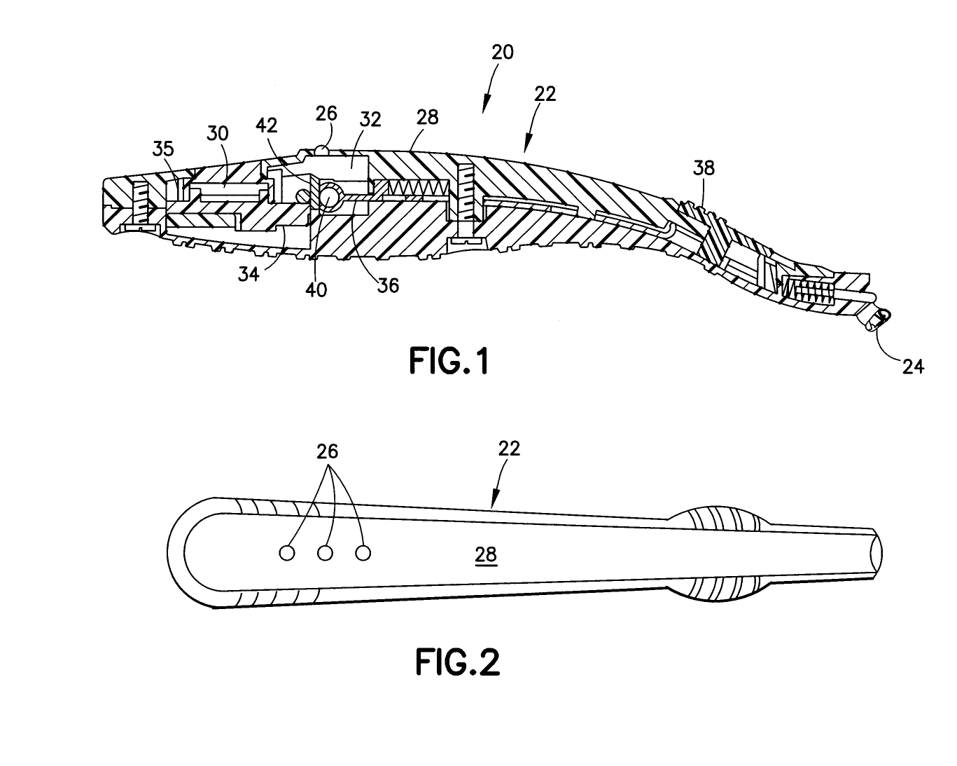

As shown in FIG. 1, a wet-shave razor in accordance with the present invention is generally designated by the reference number 20 and includes a handle 22 having a razor cartridge 24 attached at one end thereof. The razor cartridge 24 can either be permanently attached to the handle 22 as is the case with disposable wet-shave razors, or the razor cartridge can be releasably attached to the handle so that when appropriate the razor cartridge can be removed from the handle and a new cartridge releasably mounted thereon. In the illustrated embodiment an LED 26 projects outwardly from an upper surface 28 of the handle 22. While a single LED 26 has been shown in FIG. 1, the present invention is not limited in this regard as more than one LED can also be employed without departing from the broader aspects of the present invention. For example, and as shown in FIG. 2, three LED's 26 can be incorporated into the handle 24. As will be explained in detail herein, the LED's can be of the same, or different colors.

Referring back to FIG. 1, a controller 30 is positioned in an interior area 32 defined by the handle 22. The controller 30 is in electrical communication with the LED 26 which illuminates in response to command signals issued from the controller. A tilt sensor 34 is also positioned within the interior area 32 and is in communication with the controller 30. During operation, the tilt sensor 34 continuously detects tilting movement of the wet-shave razor 20 and generates signals indicative thereof, the signals being continuously receivable by the controller 30. A power supply 35, such as, but not limited to a battery is replaceably positioned within the interior area 32 defined by the handle 22. The power supply 35 is in electrical communication with the controller and any other components forming part of the wet-shave razor 20 that require power.

A reed switch generally designated by the reference number 36 is positioned within the interior area 32 and is in electrical communication with the controller 30 and an actuator 38. The actuator 38 is moveable between a cartridge retaining position wherein the razor cartridge 24 is releasably attached to the handle 22, and a cartridge releasing position wherein the razor cartridge can be removed from the handle and replaced. The reed switch 36 includes a magnet 40 that engages a contact 42 thereby completing an electric circuit. When the actuator 38 is moved from the cartridge retaining to the cartridge releasing position, the magnet 40 moves away from the contact 42 thereby breaking the circuit. As will be explained in greater detail below, signals generated by the reed switch 36 are received by the controller 30 and indicate when a razor cartridge 24 is being removed from the handle 22 and replaced.

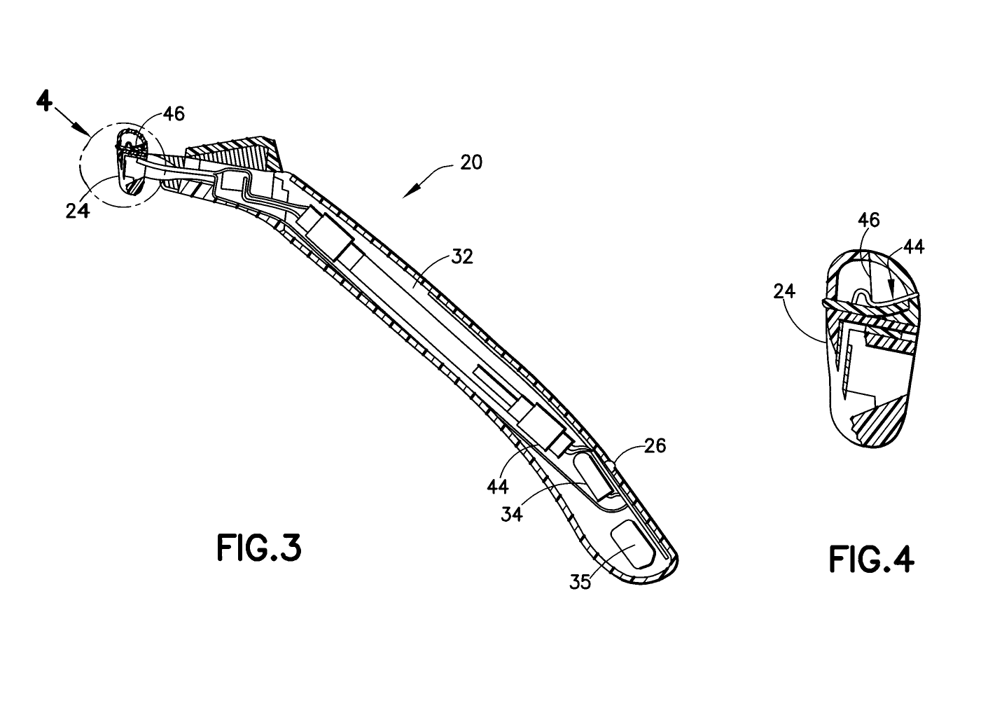

As shown in FIGS. 3 and 4, the wet-shave razor 20 can also include a moisture sensor 44 for detecting the presence of, or changes in the level of moisture with which the razor cartridge 24 comes into contact. The moisture sensor in the illustrated embodiment employs a pair of conductors 46 held closely together such as by, but not limited to twisting the conductors together at an end thereof. The conductors 46 act as a capacitor in an RC circuit. During operation, a time constant defined by the RC circuit is measured using an operational amplifier, an analog-to-digital converter and software, all forming part of, or in communication with, the controller 30. The dielectric constant between the conductors 46 determines capacitance. A change in dielectric constant will change the capacitance that is measured by the change in RC time constant. Water between the conductors 46 changes the dielectric constant and is detected as a change in the RC time constant. The controller 30 is programmed to measure the rate of change of the above-described RC time constant and thus detect rapid changes in moisture level. As will be explained in detail below, the detected changes in moisture level are used in conjunction with information received from the tilt sensor 34 to qualify when a shaving operation is occurring.

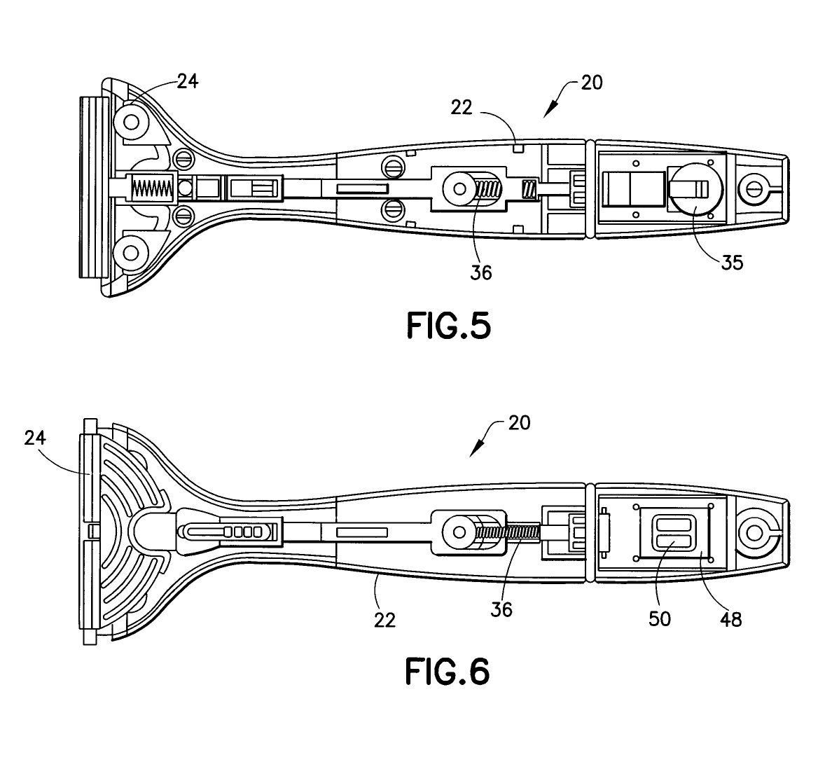

As shown in FIGS. 5 and 6 an LCD 48 in communication with the controller 30 can be employed in place of, or in addition to the above-described LED's. The LCD 48 includes a screen 50 that can display different graphics in response to commands issued from the controller 30. The graphics displayed on the screen 50 are generally indicative of the remaining useful life of the razor cartridge. The controller 30 can be a separate element in communication with the LCD 48, or the LCD and the controller can be combined into a single unit. The screen 50 is positioned in an opening in the handle 22 extending through an outer surface thereof so as to be visible to a user.

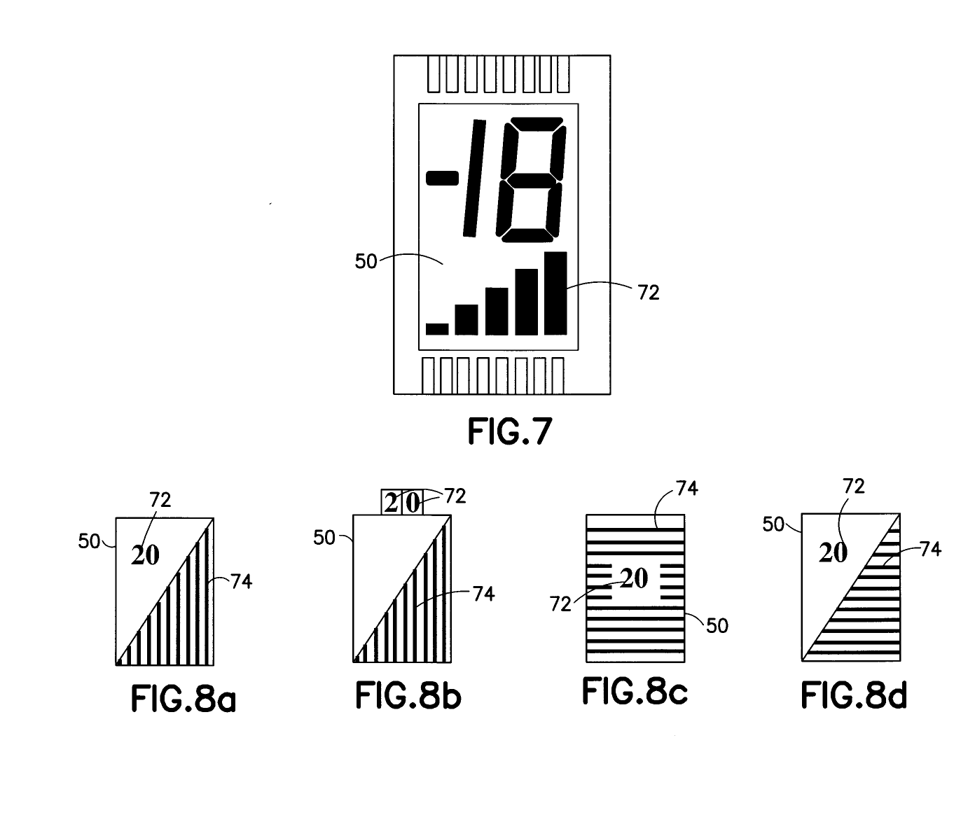

As will be explained in detail below, the graphics displayed by the LCD in general pertain to the remaining useful life of the particular razor cartridge 24 attached to the razor handle 22. As shown in FIG. 7, the LCD screen 50, in response to commands issued from the controller 30 can cause different graphics to appear. In the illustrated embodiment, the graphic consists of a number 72 and a series of bars 74 progressively increasing in length. FIGS. 8a-8d illustrate various different displays that can be shown on the LCD screen 50. However, the present invention is not limited in this regard as other display orientations can be employed without departing from the broader aspects of the present invention. Moreover, while the graphics displayed in the illustrated embodiment show both bars and numbers, the present invention is not limited in this regard as the screen 50 can also display only numbers or only bars or other graphics without departing from the broader aspects of the present invention.

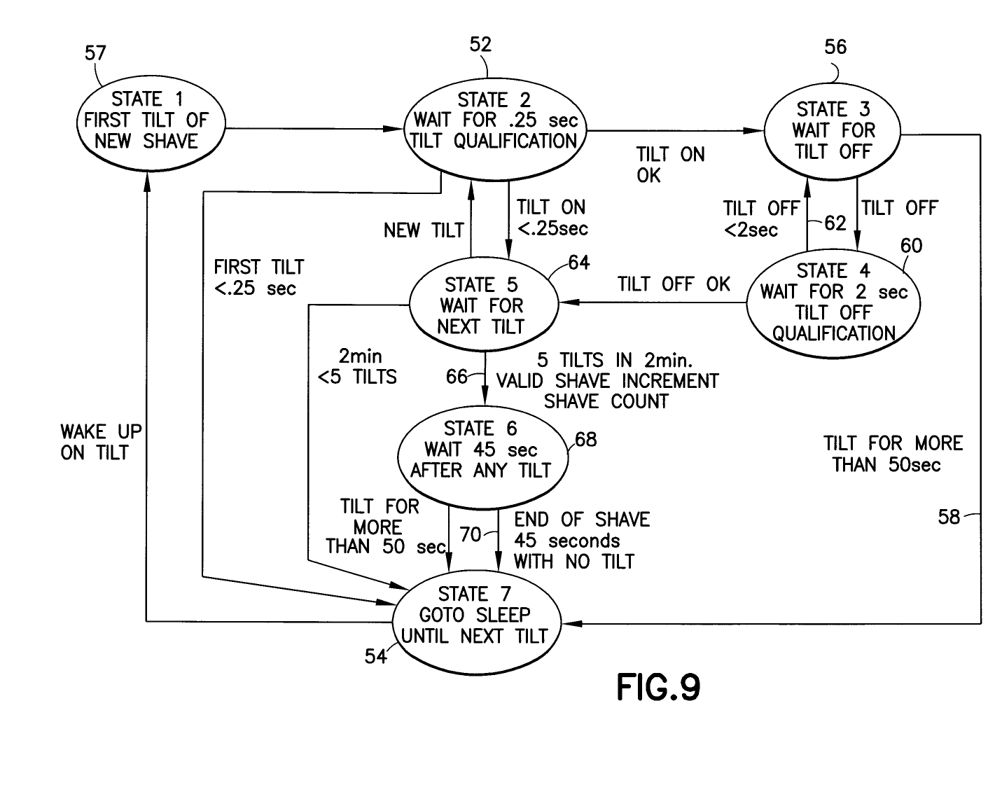

As shown in FIG. 9, with the wet-shave razor 20 configured to include the above-described tilt sensor 34, but not the moisture sensor, one mode of operation and use is described as follows.

With the razor cartridge initially at rest, such as, for example, positioned on a wash room counter, a shave qualification process is initiated when a user picks up the wet-shave razor 20 and progresses as follows.

1. The tilt sensor 34 detects the initial tilting movement 51 and generates signals indicative thereof that are received by the controller 30 causing the controller to awaken from a sleep mode.

2. The controller 30 then monitors the duration of the initial tilting motion and compares the duration to a first predetermined time value. If the duration of the initial tilting motion equals or exceeds the first predetermined time value the motion is qualified as a valid tilt 52.

3. If the duration of the initial tilting motion is less than the first predetermined time value, the controller re-enters sleep mode 54 and awaits another tilting motion.

4. Once the initial tilting motion has been qualified as a valid tilt, the controller 30 monitors the signals received from the tilt sensor 34 and waits for the motion to cease 56. If the duration of the tilting motion exceeds a second predetermined time value 58, the controller re-enters sleep mode 54.

5. When the controller 30 detects that the initial tilting motion has ceased, the controller then monitors the duration of the cessation of motion and compares this duration to a third predetermined time value 60. If the duration of the cessation of motion is less than the third predetermined time value, the controller ignores the information and continues to wait for motion to cease for a time equal to or greater than the third determined time period.

6. Once tilting motion has ceased for a time greater than or equal to the third determined time value the controller 30 then awaits the next signals from the tilt sensor 34 indicating another tilting motion 64. If the duration of the cessation of motion exceeds a fourth predetermined time value 58, then the controller re-enters sleep mode 54.

7. When the tilt sensor 34 sends signals to the controller 30 indicative of at least five valid tilting motions within a fifth predetermined time period, the controller qualifies the series of tilting motions as a valid shaving operation 66 and internally increments the count of the number of shaves for which the particular razor cartridge has been used.

8. The shaving operation is considered finished when no tilting motions are detected within a sixth predetermined time value 68, 70.

Depending on whether the wet-shave razor 20 is equipped with either an LED (S) or LCD; once a valid shaving operation is qualified the controller may send signals to the indicator to provide updated shaving information to the user. The shaving information provided is generally indicative of the useful life of the particular razor cartridge 24 coupled to the handle 22. Where an LED, or a series of LED'S as shown in FIGS. 1 and 2 are employed, depending on the information to be conveyed to the user, the controller 30 may cause the LED'S to blink a number of times indicative of the number of shaving operations for which the razor cartridge has been used or for which it may still be used. Similarly, where more than one LED is present, the controller may cause the first LED to illuminate after a first number of shaving operations has been reached, the second LED to illuminate after a second number of shaving operations has been reached, etc. In addition, the controller may send signals to the LED or LED'S causing them to blink when a predetermined number of shaves has been reached and it is time to change the razor cartridge.

Depending on the blink pattern, different parameters, such as low battery power can also be indicated to the user. There are a myriad of different illumination possibilities, as well as conditions that could be conveyed to the user via the LEDs, accordingly, the above-described examples are to be considered illustrative only, and not limiting.

In each embodiment and example described herein, each time a razor cartridge 24 is replaced on the handle 22, the controller 30 resets the shave count to one of zero or a maximum number. This occurs when the actuator 38 is moved from the cartridge retaining to the cartridge releasing position. The movement of the actuator 38 manipulates the reed switch 36 thereby causing the reed switch to generate a signal receivable by the controller 30. This signal causes the controller 30 to reset the shave count.

Where the indicator is an LCD 48 as illustrated in FIGS. 6, 7, and 8a-d, various different graphics can be displayed in response to command signals received from the controller 30. The displayed graphics are generally indicative of the remaining useful life of the particular razor cartridge 24 coupled to the handle 22. In response to the commands issued from the controller 30, the screen 50 of the LCD 48 can display a number 72, FIGS. 2 and 8a-d, that can be indicative of either the number of shaving operations for which the razor cartridge may still be used, or conversely, the number of shaving operation for which the razor cartridge has already been used. Each time another valid shaving operation is qualified, commands issued from the controller 30 cause the number displayed by the LCD screen 50 to be either increased or decreased.

In lieu of, or in addition to the numeric display 72, a graphic can also be displayed. In the illustrated embodiments, the graphics are in the form of a series of bars 74, FIGS. 2 and 8a-d. The bars 74 can be displayed in a number of different formats as shown in FIGS. 2 and 8a-d. For example, the bars can be displayed in ascending or descending order along a lower edge of the screen 50 or along a side edge of the screen. The bars 74 can also be displayed vertically or horizontally and can also extend entirely across the screen 50. During operation, the bars 74 can either be added to, or subtracted from the screen 50 depending on whether the number of shaving operations left, or the number of shaving operations accomplished is being indicated.

The LCD 48, responsive to commands issued from the controller 30 can also be caused to display other information, such as a low battery indication. In addition, the LCD can be caused to blink or display a varying graphic to indicate such things as the useful life of the particular razor cartridge 24 being exceeded. There are a myriad of different display possibilities, as well as conditions that could be conveyed to the user, accordingly, the above-described examples are to be considered illustrative, and not limiting.

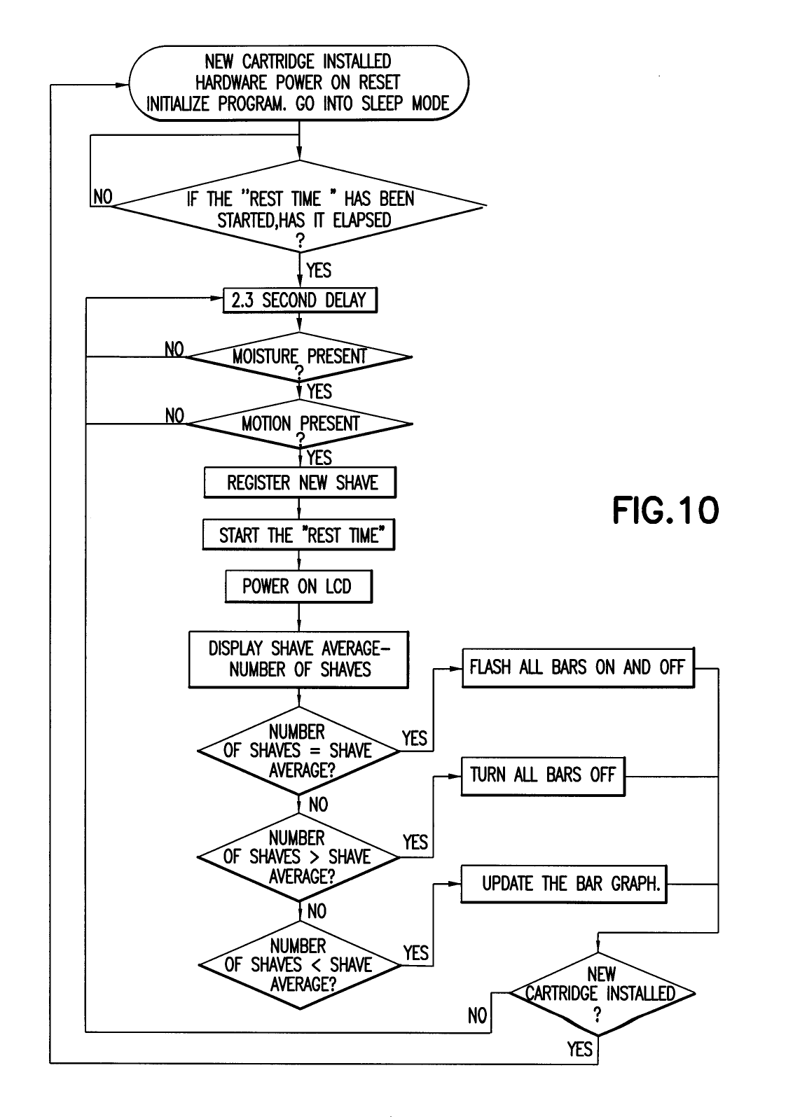

As shown in FIG. 10, the wet shave razor 20 employs both the above-described tilt sensor 34 and the moisture sensor 46. Accordingly in this method both the tilt sensor 34 and the moisture sensor 46 are employed to qualify a shaving operation. Where the moisture sensor 34 is employed, subsequent to a shaving operation, the controller goes into “rest time” or sleep mode to allow the moisture sensor to dry. Accordingly, and referring to FIG. 10, the steps for qualifying a new shave are as follows.

1. If rest time has been started 76, in general “rest time” is approximately 1 hour, and has not elapsed, the controller 30 will not exit sleep mode and the user should wait until the predetermined rest time has expired. During rest time, the LED or LCD can provide an indication to the user, such as, for example, a blinking LED or a graphic shown on the LCD indicating that the wet-shave razor is in “rest time.” If rest time has elapsed, the controller 30 routinely queries 78 the moisture sensor 34. If a change in moisture is detected 80 the controller evaluates the magnitude and rapidity of the moisture change and compares the change to a predetermined acceptable value.

2. Once a qualifying change in moisture has been detected, the controller 30 awaits a signal from the tilt sensor 34 indicating that a tilting motion is present. If no such motion is present, the controller will return to rest time to allow the moisture sensor 34 to dry. However, if tilting motion is present and sufficient as is set forth in the above-described example, then a new shaving operation is qualified.

3. Once a new shaving operation is qualified, the controller 30 issues commands to the LCD (if the wet-shave razor is so equipped) and the screen 50 is updated to reflect the newly qualified shaving operation.

The above-described operational examples each simply count the number of qualified shaving operations and provide information to a user regarding the remaining useful life of the razor cartridge, with the useful being a predetermined value programmed into the controller. However, the present invention is not limited in this regard.

The present invention also encompasses a wet shave razor having the above-described sensors and electronics forming a part thereof with the controller programmed to determine the useful life of a razor cartridge based on a particular user's actual cartridge usage. In such an embodiment, a shaving operation would be qualified in any one of the above-described manners. The controller would monitor and store the number of qualified shaves for which a cartridge is used prior to replacement and average this number over a predetermined number of razor cartridges. This average would then be stored in the controller as the useful life of a razor cartridge and the information relayed to the user via the LED's or the LCD would reflect this calculated average. In addition, the average could be constantly updated as each razor cartridge 24 is replaced. However, when a razor cartridge 24 is used for less than a predetermined minimum number of shaving operations or more than a predetermined maximum number of shaving operations this usage is disregarded by the controller 30 and not included in any determination of average cartridge usage. In this manner, changes in shaving habit, cartridge type, and/or cartridge quality could be accounted for with no need to reprogram the control or purchase a new razor handle.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A wet-shave razor comprising:
a handle;
a razor cartridge coupled to said handle, said razor cartridge having at least one razor blade positioned therein;
a sensor for continuously monitoring and detecting movement of said handle and generating signals indicative thereof;
said sensor being mounted to said handle;
a controller mounted to said handle and in communication with said sensor for continuously receiving said signals there from and for issuing commands responsive thereto;
an indicator mounted to said handle and in communication with said controller; and wherein
said indicator generates an alert responsive to said commands and indicative of the useful life of said razor cartridge, said alert being identifiable by a user.

2. A wet shave razor as defined by claim 1, wherein said handle defines an interior area, said controller being positioned therein.

3. A wet shave razor as defined by claim 2, further comprising a power supply for energizing said controller, said power supply being positioned in said interior area.

4. A wet shave razor as defined by claim 1 wherein said indicator is an LED.

5. A wet shave razor as defined by claim 1 wherein said indicator is an LCD.

6. A wet shave razor as defined by claim 1 wherein said sensor includes a tilt switch responsive to changes in the orientation of said handle, said tilt switch being positioned in an interior area defined by said handle.

7. A wet shave razor as defined by claim 1 wherein said razor cartridge is releasably coupled to said handle.

8. A wet shave razor as defined by claim 1 wherein said controller in response to said signals received from said sensor is programmed to determine when a shaving operation has begun and issue commands to said indicator indicative thereof.

9. A wet shave razor as defined by claim 8 wherein said controller is programmed to enter a sleep mode when said sensor does not detect tilting movement of said handle for a predetermined period of time.

10. A wet shave razor as defined by claim 9 wherein:
said controller is programmed to leave sleep mode upon receipt of a signal from said controller indicating that a tilting movement of said handle has occurred; and wherein
said controller, responsive to said signals received from said sensor, is further programmed to determine when a shaving operation has begun by monitoring said tilting movements and comparing these movements to predetermined parameters.

11. A method for monitoring the useful life of a razor cartridge, comprising the steps of:
providing a wet-shave razor including:
a sensor for continuously monitoring and detecting movement of said wet shave razor and generating signals indicative thereof;
a controller mounted to said wet shave razor and in communication with said sensor for continuously receiving said signals there from and for issuing commands responsive thereto; and
an indicator responsive to said commands issued from said controller;
detecting, via said sensor, an initial tilting movement of said wet-shave razor;
said sensor generating signals indicative of said tilting movement; and
said controller, responsive to said signals received from said sensor, determining when a shaving operation has begun by monitoring said tilting movements and comparing these movements to predetermined parameters.

12. A method as defined by claim 11 wherein said step of determining when a shaving operation has begun, further includes
measuring the duration of an initial tilting movement and comparing the duration to a first predetermined time value stored in said controller;
causing said controller to monitor a time duration between said initial tilting movement and the next successive tilting movement and compare said time duration to a second predetermined time value stored in said controller;
said controller qualifying said initial tilting movement as a full tilt cycle if said duration between said initial tilting movement and the next successive tilting movement is less than said second predetermined time value;
counting each successive full tilt cycle;
qualifying a series of tilting movements as a valid shave if a predetermined number of full tilt cycles occurs in less than a third predetermined time value stored in said controller; and wherein
once a valid shave has been qualified, said indicator in response to said commands issued from said controller provides information to a user relevant to the useful life of said razor cartridge.

13. A method as defined by claim 12 wherein, subsequent to said step of detecting, via said sensor, an initial tilting movement of said wet-shave razor, said method comprises the further steps of:
monitoring a duration of said tilting movement after said first predetermined time value has been exceeded and comparing said duration of said initial tilting movement to a maximum time value stored in said controller;
causing said controller to enter a sleep mode if said initial tilting movement exceeds said maximum predetermined time value.

14. A method as defined by claim 12 wherein after a shaving operation is qualified, said method comprises the further step of said controller measuring the time between tilt cycles and comparing said measured time to a predetermined value stored in said controller, and wherein if said measured time exceeds said predetermined value, said controller will enter said sleep mode.

15. A method as defined by claim 12 wherein said indicator includes at least one LED coupled to said wet shave razor, and said step of said indicator providing information to said user in response to commands from said controller includes causing said LED to selectively illuminate in a pattern dependant on the number of qualified shaves for which a particular razor cartridge has been used.

16. A method as defined by claim 15 wherein said indicator includes at least one LED coupled to said wet shave razor and said step wherein said indicator provides information to said user in response to commands from said controller includes causing said LED to selectively illuminate in different colors, said color being dependant upon the number of qualified shaves for which a particular razor cartridge has been used.

17. A method as defined by claim 15 wherein said at least one LED includes a plurality of differently colored LED's each coupled to said wet shave razor, and said step wherein said indicator provides information to said user in response to commands issued from said controller includes selectively causing each of said differently colored LED's to illuminate depending on the number of qualified shaves for which a particular razor cartridge has been used.

18. A method as defined by claim 12 wherein:
subsequent to said step of qualifying a series of tilting movements as a valid shave, said controller counts the number of valid shaves for which said razor cartridge has been used; and
said step of said indicator providing information to a user relevant to the useful life of said razor cartridge includes providing information indicative of one of, the number of valid shaves for which said razor cartridge has been used, and a number of shaves indicative of the remaining useful life of said razor cartridge.

19. A method as defined by claim 18 wherein:
said wet shave razor includes a razor cartridge releasably mounted to a handle and said wet shave razor further includes means for generating signals receivable by said controller in response to said razor cartridge being released from said handle; and wherein, subsequent to said step of counting and storing the number of valid shaves, said method includes the further step of;
said controller resetting said stored number of valid shaves to one of zero and a maximum value in response to said razor cartridge being removed from said handle and replaced with a fresh cartridge.

20. A method as defined by claim 18 wherein said indicator is an LCD and said method includes the further step of:
said indicator, responsive to said commands issued from said controller, displaying a graphic indicative of one of the number of shaves for which said razor cartridge has been used, and the number of shaves indicative of the remaining useful life of said razor cartridge.

21. A method as defined by claim 20 wherein said graphic defines a numeric display that incrementally changes each time a qualified shave is counted by said controller.

22. A method as defined by claim 20 wherein said graphic is a bar graph definable by a plurality of bars the number of which displayed is indicative of the remaining useful life of said razor cartridge.

23. A wet shave razor as defined by claim 1 wherein said razor cartridge is releasably coupled to said handle, said wet shave razor further comprising:
a magnetic reed switch positioned in an interior area defined by said handle and in communication with said controller;
an actuator movable between a cartridge retaining position wherein said razor cartridge is releasably retained on said handle and a cartridge releasing position wherein said cartridge is decoupled from said handle; and wherein
movement of said actuator from said cartridge retaining to said cartridge releasing position cause said magnetic reed switch to move to one of an engaged position or a disengaged position thereby sending a reset signal to said controller.

24. A wet-shave razor as defined by claim 3 wherein said power supply is a battery replaceably positioned in said interior area.

25. A wet-shave razor as defined by claim 1 further comprising moisture detecting means in communication with said razor cartridge for sensing changes in moisture and sending signals to said controller indicative thereof, in response to said razor cartridge coming into contact with a wet surface.

26. A method for monitoring the useful life of a razor cartridge comprising the steps of:
providing a wet-shave razor having:
a razor cartridge mounted to a handle;
a sensor for continuously monitoring and detecting movement of said wet shave razor and generating signals indicative thereof,
moisture detecting means for sensing changes in moisture and generating signals indicative thereof in response to said razor cartridge coming into contact with a moist surface; a controller in communication with said sensor and said moisture detecting means for continuously receiving said signals there from and for issuing commands responsive thereto; and
an indicator responsive to said commands issued from said controller;
causing said controller to exit a sleep mode at predetermined time intervals and command said moisture detecting means to check for a change in moisture;
if a change in moisture is sensed, measuring the degree and rate of moisture change and comparing against values stored in said controller;
causing said controller to return to said sleep mode if said measured change in moisture when compared to said stored values does not meet first predetermined criteria;
if said change in moisture meets said predetermined criteria, causing said sensor to detect titling movement of said wet-shave razor over a predetermined period of time;
if said tilting movement is present, comparing said tilting movement to second predetermined criteria stored in said controller;
if said movement meets said second predetermined criteria, causing said controller to qualify said change in moisture and said tilting movement as a valid shaving operation; and
said indicator in response to commands issued from said controller displaying information to said user relevant to the remaining useful life of said razor cartridge.

27. A method for qualifying a shaving operation as defined by claim 18 wherein said step of counting the number of valid shaves for which said razor cartridge has been used further includes:
recording the number of valid shaves for which each of a predetermined number of razor cartridges is used and determining an average cartridge usage; and wherein said step of
said indicator in response to said commands issued from said controller providing information to a user relevant to the useful life of said razor cartridge; further includes
providing information indicative of said useful life based upon said average cartridge usage determined by said controller.

28. A method for qualifying a shaving operation as defined by claim 25 wherein said step of counting the number of valid shaves for which said razor cartridge has been used further includes:
recording the number of valid shaves for which each of a predetermined number of razor cartridges is used and determining an average cartridge usage; and wherein said step of
said indicator in response to said commands issued from said controller providing information to a user relevant to the useful life of said razor cartridge; further includes
providing information indicative of said average cartridge usage to said user.

29. A wet shave razor as defined by claim 1 further comprising means for resetting said controller in response to said razor cartridge being removed from said handle.

30. A method as defined by claim 28 wherein said step of recording the number of valid shaves for which each of a predetermined number of razor cartridges is used and determining an average cartridge usage, further includes:
updating said average cartridge usage for each successive razor cartridge coupled to said wet shave razor by causing said controller to recalculate said average cartridge usage by considering the number of shaving operations for which a previous cartridge is used each time said previous cartridge is removed from said wet-shave razor.

31. A method as defined by claim 30 wherein said number of shaving operations for which said previous cartridge is used is disregarded in determining said average cartridge usage if said number of shaving operations is one of less then a minimum value and greater that a maximum value.
